(19) United States
(12) Patent Application Publication
(10) Pub. No.: US 2010/0014798 A1
(43) Pub. Date: Jan. 21, 2010

(54) ASSEMBLY ON A MOTOR VEHICLE FOR CONNECTING AN OUTER BEARING RING OF A ROLLING BEARING AND A WHEEL SUPPORT, AND METHOD FOR THE PRODUCTION OF SUCH A CONNECTING ASSEMBLY

(75) Inventors: Raphael Fischer, Schweinfurt (DE); Peter Niebling, Bad Kissingen (DE); Christian Hecker, Schweinfurt (DE); Darius Dlugai, Schweinfurt (DE); Ralf Hund, Ruppertshofen (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/301,280

(22) PCT Filed: May 10, 2007
(86) PCT No.: PCT/DE2007/000851

§ 371 Date: Mar. 19, 2009

(30) Foreign Application Priority Data
May 19, 2006 (DE) 10 2006 023 547.9

(51) Int. Cl. F16C 43/04; B23P 17/00

(52) U.S. Cl. 384/585; 29/898.07

(57) ABSTRACT

The invention relates to an assembly on a motor vehicle for connecting an outer bearing ring of a rolling bearing and a wheel support which is formed by two cup-shaped molded sheet metal parts that can be fixedly connected so as to form a hollow profiled element. Each of the molded sheet metal parts is provided with a circular hole that is coaxial with the axis of rotation of the rolling bearing, said holes being spaced apart from one another. The space between the holes is occupied by a spacing ring which is axially supported on the inner edges of the molded sheet metal parts, said edges defining the two circular holes, in such a way that a tubular bearing receptacle for the outer bearing ring of the rolling bearing is formed and the molded sheet metal parts are fixedly connected to the spacing ring and the outer bearing ring of the rolling bearing in a positive and frictionally engaged manner.

### FIELD OF THE INVENTION

The invention relates to an assembly on a motor vehicle for connecting an outer bearing ring of a rolling bearing and a wheel support, wherein the wheel support is formed by two saucer-type molded sheet-metal parts which can be connected fixedly to form a hollow profile, and the molded sheet-metal parts respectively have a circular opening which is coaxial with respect to the axis of rotation of the rolling bearing, said openings being spaced apart from each other. The invention furthermore relates to a method for the production of such a connecting assembly.

### BACKGROUND OF THE INVENTION

Assemblies for connecting a rolling bearing and a wheel support have long been known in a very wide variety of embodiments.

For example, it is known from DE 44 36 789 A1 to fix the outer bearing ring of a two-row deep-groove ball bearing in a passage bore of the wheel support with an interference fit. The axial securing of the outer bearing ring is ensured by means of a snap ring which is associated with an increased weight and increased manufacturing outlay.

DE 103 59 649 A1 and DE 196 13 441 A1 disclose a wheel bearing unit with a hub onto which at least one inner ring is pushed, said inner ring, together with rolling bodies and an integral outer ring, forming the wheel bearing. The axial fixing and prestressing of the inner rings on the hub is realized by means of a radial bead which is produced by means of rolling rivets with the aid of plastic cold working and is integrally formed at the end of the hub.

Furthermore, a pivot bearing for the front axle of a front-wheel-drive motor vehicle is known from DE 199 15 633 A1, said pivot bearing having a basic body which comprises molded sheet-metal parts which can be connected to each other or comprises an inner and an outer shell, to which components for the wheel suspension and wheel control and also wheel braking are fastened. It is proposed there to produce the molded sheet-metal parts by means of a deep-drawing operation, said parts, which are joined to each other via a welding connection, then forming a hollow body with a plurality of connecting surfaces for the protruding components. A tubular wheel bearing receptacle, also referred to as a seat ring, can be inserted into an opening in the basic body and can be connected fixedly to the basic body by welding.

The wheel bearing is conventionally pressed into the abovementioned wheel bearing receptacle or into the seat ring. This solution also requires a supplementary axial securing means in order, inter alia, to prevent the outer bearing ring from migrating axially, which results in undesirable noises.

### OBJECT OF THE INVENTION

The invention is based on the object of providing an assembly on a motor vehicle for connecting an outer bearing ring of a rolling bearing and a wheel support formed from saucer-type molded sheet-metal parts, as is known, for example, from DE 199 15 633 A1, which connecting assembly can on the one hand be produced more simply and cost-effectively and on the other hand avoids separate and accordingly additional and accordingly complicated measures for the axial securing of the outer bearing ring.

A further object is to provide a suitable method for the production of such a connecting assembly.

### SUMMARY OF THE INVENTION

The invention achieves this object by means of a connecting assembly according to the features of the main claim and by means of a production method according to the further independent method claim.

Advantageous developments and refinements of the invention can be gathered from the respectively assigned dependent claims.

The invention is therefore firstly based on an assembly on a motor vehicle for connecting an outer bearing ring of a rolling bearing and a wheel support, wherein the wheel support is formed by two saucer-type molded sheet-metal parts which can be connected fixedly to form a hollow profile.

As an advantageous development, it can be provided here that the molded sheet-metal parts are arranged transversely with respect to the axis of rotation of the rolling bearing. With regard to the connectability of the saucer parts, it is proposed, as a development, that they can be connected by a connection by means of welding, adhesive bonding, soldering, punch riveting, riveting, clinching or screwing.

Furthermore, the molded sheet-metal parts respectively have, according to the invention, a circular opening which is coaxial with respect to the axis of rotation of the rolling bearing, said openings being spaced apart from each other.

In addition, it is provided in the case of this connecting assembly that said spacing is occupied by a spacer ring which is axially supported on the inside on the edges of the molded sheet-metal parts, which edges delimit the two circular openings in such a manner, that a tubular bearing receptacle is formed for the outer bearing ring of the rolling bearing, and that the molded sheet-metal parts are connected fixedly to the spacer ring and the outer bearing ring of the rolling bearing by means of a form-fitting and frictional connection.

According to an advantageous refinement of the invention, the outer bearing ring of the rolling bearing has, at one end, a radially deposited annular flange by means of which the outer bearing ring, in the fitted state, is axially supported on the associated outer end side of the tubular bearing receptacle formed.

According to an advantageous refinement, at the opposite end the outer bearing ring can have an annular section which protrudes axially over the bearing receptacle, can be deformed by a deformation operation to form a collar and can be fixed axially to the other, outer end side of the tubular bearing receptacle.

The deformation can be brought about here by means of cold deformation, for example plastic cold deformation by rolling riveting, or else by means of hot deformation, for example by inductive heating and folding over.

Said axial fixing or supporting of the outer bearing ring in this manner by an already existing collar, on one end side, and/or by a collar which is to be formed, on the other end side, may also be realized—which is covered by means of the invention in combinations—just on one side by means of one of the abovementioned collars or else on both sides in a mirror-inverted manner by means of in each case one of the abovementioned collars.

The axial fixing or else supporting of the outer ring can also be brought about in that the bearing receptacle has stepped or conical cross sections corresponding to the outer ring.

According to a particularly preferred embodiment, in order to produce the connecting assembly, the annular section of the outer bearing ring of the rolling bearing, which annular section protrudes axially over the bearing receptacle, can be deformed, in particular can be deformed cold, by a rolling rivet process.

Furthermore, it is proposed that the spacer ring is designed flexibly such that the assembly comprising molded sheet-metal parts, spacer ring and outer bearing ring of the rolling bearing can be braced per se by deformation of the annular section protruding over the bearing receptacle. For this purpose, the spacer ring can have one or more radial constrictions in a central annular section. Similarly, the spacer ring can also be designed as a cylindrical deformed part with radial webs pointing radially inward at both ends and with a narrowing or radial constriction which can optionally be provided.

The spacer ring can also be designed as a corrugated ring.

Furthermore, it is proposed that abutting edges of the spacer ring are connected to each other by welding, clinching and/or similar methods.

As can furthermore be provided by the invention, the two edges of the molded sheet-metal parts, which edges delimit the circular openings, can have an encircling thickened portion which can be formed by folding over or by compressing the respective edge.

In addition, it can be provided that the materials used for the respectively adjacent components in the form of the spacer ring and the molded sheet-metal parts differ in their hardness in such a manner that, by means of said deformation of the annular section of the outer bearing ring, which annular section protrudes axially over the bearing receptacle, deformation of the connecting contour of the component having the softer material and nestling of the same against the connecting contour of the component having the harder material is brought about at the same time.

In this case, the connecting contour of the component having the harder material can be designed with a profiled portion in such a manner that, by means of the deformation of the connecting contour of the component having the softer material and nestling of the same against the connecting contour of the component having the harder material, a form-fitting connection is brought about between the connecting contours of the adjacent components.

However, the form-fitting connection can also be brought about without significant deformation during assembly by means of pre-shaped geometries, for example an undercut, at the contact points.

The method for the production of an assembly on a motor vehicle for connecting an outer bearing ring of a rolling bearing and a wheel support, wherein the wheel support is formed by two saucer-type molded sheet-metal parts which can be connected fixedly to form a hollow profile, and the molded sheet-metal parts respectively have a circular opening which is coaxial with respect to the axis of rotation of the rolling bearing, said openings being spaced apart from each other, is characterized by the following method steps to be carried out successively:
a) between the two mutually spaced-apart circular openings of the molded sheet-metal parts, a spacer ring which is axially supported on the inside on the two edges of the molded sheet-metal parts, which edges delimit the openings, is positioned in such a manner that a tubular bearing receptacle is formed for the outer bearing ring of the rolling bearing.
b) The two molded sheet-metal parts are connected fixedly to each other.
c) An outer bearing ring which is designed at one end with an annular section which, in the fitted state, protrudes axially over the annular bearing receptacle formed, is pushed into the bearing receptacle.
d) The annular section of the outer bearing ring, which annular section protrudes axially over the bearing receptacle, is deformed by a deformation operation to form a collar.

With regard to the method step a), the two edges of the molded sheet-metal parts, which edges delimit the circular openings, can each be provided beforehand with an encircling thickened portion. The thickened portions for their part can be formed by folding over or compressing the respective edge.

With regard to the method step b), it is proposed that the two molded sheet-metal parts are connected fixedly to each other by welding. Other connections, such as adhesive bonding, soldering, punch riveting, riveting, clinching or screwing, are also possible.

It is furthermore proposed that, with regard to the method step d), the annular section of the outer bearing ring of the rolling bearing, which annular section protrudes axially over the bearing receptacle, is deformed, in particular deformed cold, by a rolling rivet process.

Furthermore, it is proposed that, with regard to the method step d), with which axial fixing of the outer bearing ring and/or axial supporting of the outer bearing ring is brought about (at one end), it may also be provided that there already is a restraining flange at the other end of the outer bearing ring, or such a restraining flange is formed by deformation, in particular according to method step d).

The axial fixing or else supporting of the outer ring can also be brought about in that the bearing receptacle has stepped or conical cross sections corresponding to the outer bearing ring.

According to a further advantageous development of the invention, use is made of a spacer ring which is designed resilient such that the assembly comprising molded sheet-metal parts, spacer ring and outer bearing ring of the rolling bearing is braced per se by the deformation of the annular section protruding over the bearing receptacle.

For example, use can be made of a spacer ring which has one or more radial constrictions in a central annular section. By contrast, use can also be made of a spacer ring in the form of a cylindrical deformed part with radial webs pointing radially inward at both ends and with a radial narrowing or constriction which can optionally be provided.

A corrugated spacer ring can also be used.

A further measure makes provision that materials are used for the respectively adjacent components in the form of the spacer ring and the molded sheet-metal parts, which materials differ in their hardness in such a manner that, by means of the deformation of the annular section of the outer bearing ring, which annular section protrudes over the bearing receptacle, deformation of the connecting contour of the component having the softer material and nestling of the same against the connecting contour of the component having the harder material is brought about at the same time.

Finally, the connecting contour of the component having the harder material can be designed with a profiled portion in such a manner that, by means of deformation of the connecting contour of the component having the softer material and nestling of the same against the connecting contour of the component having the harder material, a form-fitting connection is brought about between the connecting contours of the adjacent components.

The proposed connecting assembly and the proposed method for the production of such a connecting assembly have a number of advantages over the prior art.

On the one hand, said connecting assembly can be produced particularly simply and cost-effectively since, apart from the connection of the two molded sheet-metal parts to each other by, for example, welding, the assembly comprising the hollow profile, which is formed by molded sheet-metal parts, and the spacer ring and also the outer bearing ring can be brought about exclusively by means of a form-fitting and frictional connection. During the assembly, the one free end of the outer bearing ring or the annular section of the outer bearing ring, which annular section protrudes over the bearing receptacle, merely needs to be deformed by a deformation process to form a collar and fixed to the relevant outer end side of the bearing receptacle.

Additional bonding measures, as provided by the prior art in the form of welding, for example, a seat ring to the molded sheet-metal parts, are now unnecessary.

On the other hand, because of the particular arrangement of the spacer ring and the manner of the fastening, an increased clamping force is registered, since the spacer ring acts, as it were, as a compression spring and accordingly provides higher reserve to a possible settling behavior of the assembly.

### BRIEF DESCRIPTION OF THE DRAWINGS

The invention is explained in more detail below using a number of embodiments and with reference to the attached drawings, in which:

FIG. 1 shows a connecting assembly according to the invention in a longitudinal section at the beginning of the assembly of the same,

FIG. 2 shows the connecting assembly according to FIG. 1 at an advanced time during its assembly,

FIG. 3 shows the connecting assembly according to FIG. 1 and FIG. 2 in the ready-fitted state,

FIGS. 4a to 4d show possible advantageous developments of the spacer ring,

FIGS. 5a and 5b show a first advantageous refinement of the edges delimiting the circular openings of the molded sheet-metal parts, before and after assembly,

FIGS. 6a and 6b show a further advantageous refinement of the edges, and

FIGS. 7a to 7c show a possible advantageous refinement of the spacer ring.

### DETAILED DESCRIPTION OF THE DRAWINGS

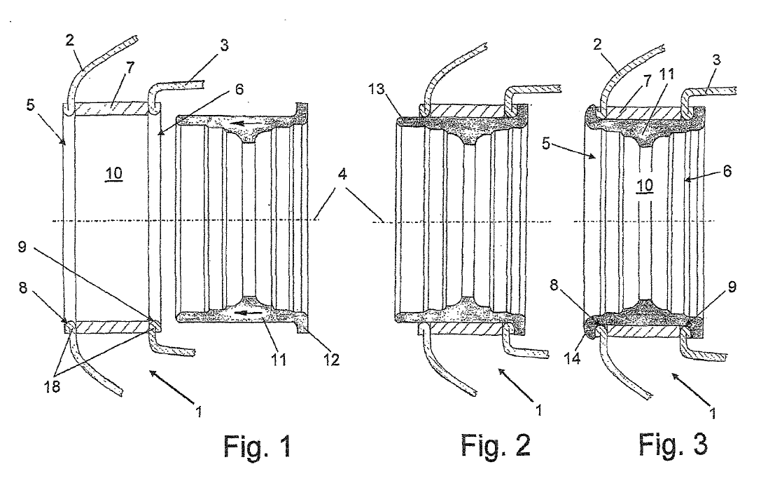

As illustrated schematically in the cross-sectional drawing of FIG. 1 and known from DE 199 15 633 A1 already mentioned at the beginning, the wheel support 1 comprises two saucer-type molded sheet-metal parts 2 and 3, namely an outer and an inner molded sheet-metal part which, for their part, are arranged transversely with respect to the axis of rotation 4 of a rolling bearing (not shown specifically in detail).

The two molded sheet-metal parts 2 and 3 can be connected fixedly to form a hollow profile and, for this purpose, are preferably welded to each other in the region of connecting surfaces (not shown specifically). The two molded sheet-metal parts 2 and 3 respectively have a circular opening 5 and 6 which is coaxial with respect to the axis of rotation 4 of the rolling bearing, said openings being spaced apart axially from each other. Said spacing between the two openings 5 and 6 is occupied by a spacer ring 7 made of steel or another suitable material, by said spacer ring being inserted, during assembly of the wheel support 1, between the two edges 8, 9 of the molded sheet-metal parts 2, 3, which edges delimit the circular openings 5 and 6. This takes place in such a manner that the spacer ring 7 is supported axially on the opposite edges 8, 9 of the molded sheet-metal parts 2 and 3 such that a tubular bearing receptacle 10 is formed for an outer bearing ring 11 of the rolling bearing.

The outer bearing ring 11, the outer contour of which is to a large extent of cylindrical design, has, at one end, a radially deposited annular flange 12 by means of which said outer bearing ring, in the fitted state, i.e. after the same is introduced axially into the tubular bearing receptacle 10, is axially supported on an assigned axially outer end side of the bearing receptacle 10 (FIG. 2).

At the other end, the outer bearing ring 11 has an annular section 13 which protrudes axially over the bearing receptacle 10. As illustrated in FIG. 3, said annular section 13 can be deformed by a deformation operation—for example by cold deformation in this case—to form a collar 14 and is then fixed axially to the other end side of the tubular bearing receptacle 10. To produce said collar 14, the rolling rivet process which is known per se is in particular appropriate.

By means of this construction, the molded sheet-metal parts 2 and 3, which are connected to form a hollow profile, are connected fixedly in a form-fitting and frictional manner both to the spacer ring 7 and to the outer bearing ring 11 of the rolling bearing by the collar 14, which is fixed onto the outer end side, being formed from the annular section 13 by riveting. Further fastening measures as are provided in the prior art, for example welding connections, are now unnecessary.

It has proven particularly advantageous if the spacer ring 7 is produced such that it is resilient to a limited extent. The latter can thus be deformed elastically within limits during assembly, in particular by means of the deformation of the annular section 13 of the outer bearing ring 11, as a result of which the assembly comprising the two molded sheet-metal parts 2 and 3, the spacer ring 7 and outer bearing ring 11 is braced to form a fixed subassembly. In this case, the spacer ring 7 acts as a compression spring and provides higher clamping forces and higher reserve with regard to a settling behavior of the assembly formed.

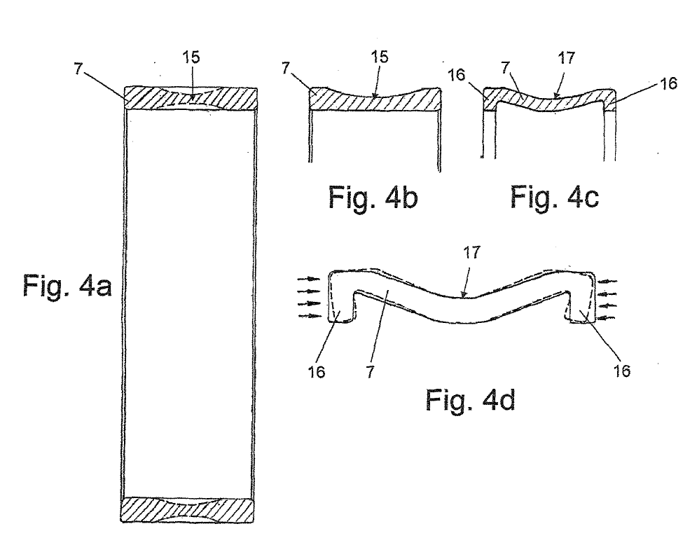

FIG. 4a shows, in an axial section, a spacer ring 7 which is designed in such a manner and has a cylindrical basic shape and, in the present case, has, in a central annular section, a constriction 15 which is directed radially inward or outward from the inner and the outer contour of the spacer ring 7.

Of course, a plurality of constrictions 15 arranged axially consecutively on the inner and/or outer side or contour are also possible and, accordingly, are incorporated by the invention. Like-wise, as shown in FIG. 4b, the constriction 15 can also merely be constricted to the outer contour or else to the inner contour of the spacer ring 7.

The constriction 15 ensures the desired resilience in said central annular section, whereas the higher restraining flange is supporting in the edge region.

By contrast, FIG. 4c shows a spacer ring 7 as a cylindrical deformed sheet-metal part having radial webs 16 pointing inward at the axial ends, and a narrowing 17. The desired resilience of the spacer ring 7 can also be obtained by this particular development of the same by, as illustrated schematically in FIG. 4d, the free ends or the radial webs 16 of the spacer ring 7 yielding by the application of force as a consequence of the deformation of the annular section 13 of the outer bearing ring 11 or as a consequence of the riveting force and, accordingly, advantageously facilitating the form-fitting connection to the molded sheet-metal parts 2 and 3 of the wheel support 1.

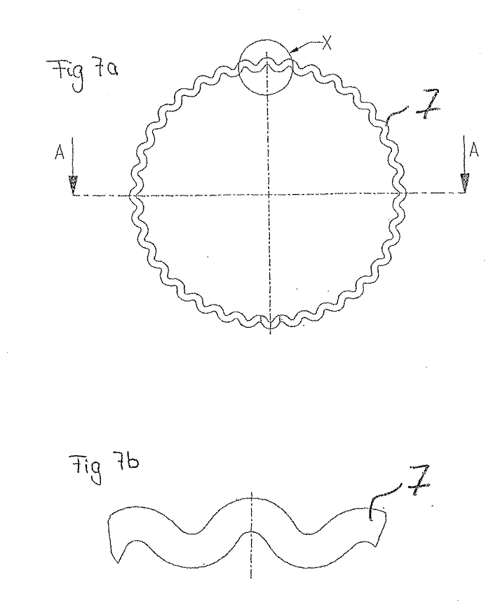

In order to advantageously further assist the frictional connection in the riveted joint, it has proven expedient to provide the two edges 8 and 9 of the molded sheet-metal parts 2 and 3, which edges delimit the circular openings 5 and 6, with an encircling thickened portion 18 beforehand. The thickened portions 18 can be formed by folding over the respective edge 8 or 9 (FIGS. 1 to 3, 5a, 5b) or by compressing the ends of the same (FIGS. 6a, 6b).

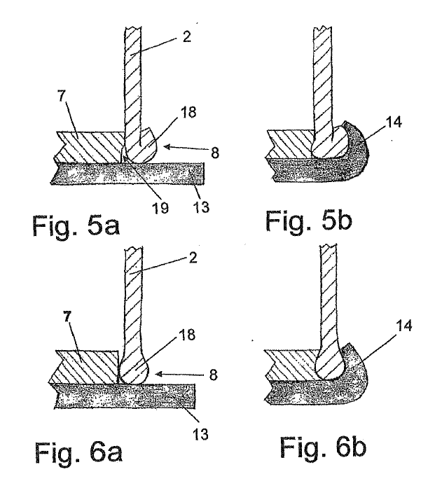

If the material used for the molded sheet-metal parts 2 and 3 or for the abovementioned thickened portions 18 is softer than the material of the connected spacer ring 7, and if the spacer ring 7 has a profiled portion 19, for example in the region of its connecting contour, then, as a consequence of the axial force which is in effect by means of the deformation of the annular section 13 which protrudes axially over the bearing receptacle 10, a deformation of the connecting contour of the edges 8 and 9 of the molded sheet-metal parts 2, 3 is brought about at the same time by said edges nestling against the connecting contour, which is composed of a harder material, of the spacer ring 7, which is designed with a profiled portion 19 in the present case, and entering into a form-fitting connection therewith (compare in particular FIGS. 5a and 5b).

FIGS. 6a and 6b show an opposed development of the components by compressed edges 8 and 9 of the molded sheet-metal parts 2 and 3 being composed of a harder material than the spacer ring 7 and, accordingly, material of the connecting contour of the spacer ring 7 nestling plastically against the connecting contour of the molded sheet-metal parts 2, 3 or against the edges 8, 9 thereof, and, in the present case, at least partially enclosing a drop-shaped cross section of the edges 8, 9 together with the deformed collar 14 of the annular section 13 of the outer bearing ring 11.

If the outer bearing ring 11, as described above, is fitted fixedly to the wheel support 1, then the latter can be completed in a manner known per se with all of the further bearing and add-on parts required, such as inner bearing ring, rolling body, wheel hub, etc. (not illustrated specifically).

It is likewise conceivable to insert an already completed bearing with a protruding annular section 13 into the bearing receptacle 10 and to fit the bearing by deformation of the annular section 13.

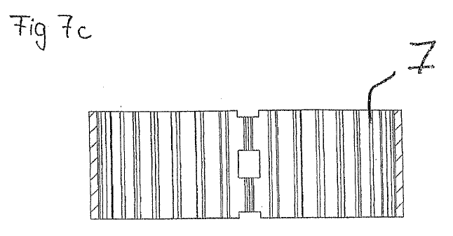

FIGS. 7a to c show a further possible advantageous refinement of the spacer ring 7, namely a spacer ring 7 which is designed as a corrugated ring. By means of a spacer ring 7 designed in such a manner, weight can be saved while contact at the same time is as wide as possible in order to reduce stress peaks.

FIG. 7a shows said corrugated spacer ring in cross section. As an alternative to the corrugated refinement of the spacer ring 7, the latter can also be designed in a sharp “zig zag”.

FIG. 7b shows in detail the region indicated in FIG. 7a by an “X”. FIG. 7c shows a section through the corrugated spacer ring 7 with a view of a possible embodiment of an abutting edge.

As FIG. 7c shows, a welded butt joint is illustrated in this case. As an alternative to the welding, the connection can also be realized by clinching.

### REFERENCE NUMBERS

1 Wheel support

2 Outer molded sheet-metal part

3 Inner molded sheet-metal part

4 Axis of rotation

5 Opening in the molded sheet-metal part 2

6 Opening in the molded sheet-metal part 3

7 Spacer ring

8 Edge at opening 5

9 Edge at opening 6

10 Bearing receptacle

11 Outer bearing ring

12 Annular flange

13 Annular section on the outer bearing ring 11

14 Collar

15 Constriction in the spacer ring 7

16 Radial web in the spacer ring 7

17 Narrowing in the spacer ring 7

18 Thickened portion

19 Profiled portion

1. An assembly on a motor vehicle for connecting an outer bearing ring of a rolling bearing and a wheel support, comprising a wheel support formed by two saucer-type molded sheet-metal parts which can be connected fixedly to form a hollow profile, and the molded sheet-metal parts respectively have a circular opening which is coaxial with respect to the axis of rotation of the rolling bearing, said openings being spaced apart from each other, wherein said spacing is occupied by a spacer ring which is axially supported on the inside on the edges of the molded sheet-metal parts, which edges delimit the two circular openings, in such a manner that a tubular bearing receptacle is formed for the outer bearing ring of the rolling bearing, and in that the molded sheet-metal parts are connected fixedly to the spacer ring and the outer bearing ring of the rolling bearing by means of a form-fitting and frictional connection.

2. The connecting assembly as claimed in claim 1, wherein the outer bearing ring of the rolling bearing has, at least at one end, a radially deposited annular flange by means of which the outer bearing ring, in the fitted state, is axially supported on an associated end side of the tubular bearing receptacle formed, and/or has, at least at the other end, an annular section which protrudes axially over the bearing receptacle, can be deformed by a deformation operation to form a collar and can be fixed axially to the other, outer end side of the tubular bearing receptacle.

3. The connecting assembly as claimed in claim 2, wherein the annular section the outer bearing ring of the rolling bearing, which annular section protrudes over the bearing receptacle, can be deformed, in particular can be deformed cold, by a rolling rivet process.

4. The connecting assembly as claimed in claim 1, wherein the spacer ring is designed resiliently such that the assembly comprising molded sheet-metal parts, spacer ring and outer bearing ring of the rolling bearing can be braced per se by deformation of the annular section protruding over the bearing receptacle.

5. The connecting assembly as claimed in claim 4, wherein the spacer ring has one or more constrictions, in particular constrictions arranged radially on the inside or outside, in a central axial annular section.

6. The connecting assembly as claimed in claim 4, wherein the spacer ring is designed as a cylindrical deformed part with radial webs pointing inward at both ends and with a possible narrowing, and/or in that the spacer ring is designed as a corrugated ring.

7. The connecting assembly as claimed in claim 1, wherein the molded sheet-metal parts are connected fixedly to each other by welding, and/or in that the molded sheet-metal parts are arranged transversely with respect to the axis of rotation of the rolling bearing.

8. The connecting assembly as claimed in claim 1, wherein the two edges of the molded sheet-metal parts, which edges delimit the circular openings, have an encircling thickened portion.

9. The connecting assembly as claimed in claim 8, wherein the thickened portion is formed by folding over or by compressing the respective edge.

10. The connecting assembly as claimed in claim 1, wherein the materials used for the respectively adjacent components in the form of the spacer ring and the molded sheet-metal parts differ in their hardness in such a manner that, by means of the deformation of the annular section of the outer bearing ring, which annular section protrudes axially over the bearing receptacle, deformation of the connecting contour of the component having the softer material and nestling of the same against the connecting contour of the component having the harder material can be brought about at the same time.

11. The connecting assembly as claimed in claim 10, wherein the connecting contour of the component having the harder material is designed with a profiled portion in such a manner that, by means of deformation of the connecting contour of the component having the softer material and nestling of the same against the connecting contour of the component having the harder material, a form-fitting connection can be brought about between the connecting contours of the adjacent components.

12. The connecting assembly as claimed in claim 1, wherein the bearing receptacle has stepped or conical cross sections corresponding to the outer bearing ring.

13. A method for the production of an assembly on a motor vehicle for connecting an outer bearing ring of a rolling bearing and a wheel support, comprising: forming a wheel support by two saucer-type molded sheet-metal parts which can be connected fixedly to form a hollow profile, and the molded sheet-metal parts respectively have a circular opening which is coaxial with respect to the axis of rotation of the rolling bearing, said openings being spaced apart the rolling bearing, said openings being spaced apart from each other, wherein the following method steps are carried out successively:
a) positioning between the two mutually spaced-apart circular openings of the molded sheet-metal parts, a spacer ring which is axially supported on the inside on the two edges of the molded sheet-metal parts, which edges delimit the openings, in such a manner that a tubular bearing receptacle is formed for the outer bearing ring of the rolling bearing;
b) connecting the two molded sheet-metal parts are fixedly to each other;
c) pushing the outer bearing ring which is designed at one end with an annular section which, in the fitted state, protrudes axially over the annular bearing receptacle formed, into the bearing receptacle (10); and
d) deforming the annular section of the outer bearing ring, which annular section protrudes axially over the bearing receptacle, by a deformation operation to form a collar.

14. The method as claimed in claim 13, wherein, with regard to the method step a), the two edges of the molded sheet-metal parts, which edges delimit the circular openings, are each provided before-hand with an encircling thickened portion.

15. The method as claimed in claim 14, wherein the thickened portions are formed by folding over or compressing the respective edge of the molded sheet-metal parts.

16. The method as claimed in claim 13, wherein, with regard to the method step b), the two molded sheet-metal parts are connected fixedly to each other by welding.

17. The method as claimed in claim 13, wherein, with regard to the method step d), the annular section of the outer bearing ring of the rolling bearing, which annular section protrudes over the bearing receptacle, is deformed, in particular deformed cold, by a rolling rivet process.

18. The method as claimed in claim 13, wherein there already is a restraining flange at the other end of the outer bearing ring, or such a restraining flange is formed by deformation, in particular corresponding to the method step d).

19. The method as claimed in claim 13, wherein use is made of a spacer ring which is designed resiliently within limits such that the assembly comprising molded sheet-metal parts, spacer ring and outer bearing ring of the rolling bearing is braced per se by the deformation of the annular section protruding over the bearing receptacle.

20. The method as claimed in claim 19, wherein use is made of a spacer ring which has one or more radial constrictions, in particular constrictions arranged radially on the inside or outside, in a central axial annular section.

21. The method as claimed in claim 20, wherein a spacer ring which is designed as a cylindrical deformed sheet-metal part with pointing inward radial webs and at both axial ends and with possibly a narrowing is used.

22. The method as claimed in claim 13, wherein materials are used for the respectively adjacent components in the form of the spacer ring and the molded sheet-metal parts, which materials differ in their hardness in such a manner that, by means of the deformation of the annular section of the outer bearing ring, which annular section protrudes axially over the bearing receptacle, deformation of the connecting contour of the component having the softer material and nestling of the same against the connecting contour of the component having the harder material is brought about at the same time.

23. The method as claimed in claim 22, wherein the connecting contour of the component having the harder material is designed With a profiled portion in such a manner that, by means of deformation of the connecting contour of the component having the softer material and nestling of the same against the connecting contour of the component having the harder material, a form-fitting connection is brought about between the connecting contours of the adjacent components.
